(19) United States
(12) Patent Application Publication
(10) Pub. No.: US 2016/0287012 A1
(43) Pub. Date: Oct. 6, 2016

(54) PORTABLE HEATING CONTAINER

(71) Applicant: DOKDO CO., LTD, Yongin-si Gyeonggi-do (KR)

(72) Inventor: Su-Hwan Ra, Yongin-si, Gyeonggi-do (KR)

(21) Appl. No.: 14/892,995

(22) PCT Filed: Nov. 12, 2014
(86) PCT No.: PCT/KR2014/010877

§ 371 Date: Nov. 20, 2015

(51) Int. Cl. A47J 36/24; A47J 36/28; A47J 39/00

(52) U.S. Cl. CPC A47J 36/2416; A47J 36/2405; A47J 36/2438; A47J 39/00; A47J 36/28

(57) ABSTRACT

The present invention relates to a heating container. More particularly, the invention relates to a portable heating container to conveniently heat foods, such as beverages, etc. The present invention, the portable heating container, comprises an outer container into which an inner container which contains foods is inserted and the heating substances that is to react to water are housed; and cover members which are detachably fixed to an open entrance of the outer container, in which a through-hole through which the inner container penetrates is formed, and in which an emission groove through which water vapors are emitted is formed around the through-hole.

### TECHNICAL FIELD

The present invention relates to a heating container. More particularly, the invention relates to a portable heating container to conveniently heat foods, such as beverages, etc.

### PRIOR ART

People have to prepare for heating devices, such as a burner, etc. to heat or cook foods in their outdoor activities such as mountain climbing, fishing, etc., whereas foods may be cooked or heated indoors without difficulty due to heating devices therein. Furthermore, the use of a heating device is restricted or even prohibited in many places due to danger such as a fire and environmental pollution it may cause. Thus, it is much more difficult to cook or heat foods in these places.

Thus, people have to buy foods in neighboring areas or used a separate heat retaining container for their foods, while they enjoy their outdoor activities in place where the foods can't be cooked. It is inconvenient to carry a heat retaining container and its heat retaining capacity is limited in terms of time. Moreover, people can't conveniently cook foods with the heating retaining container where they want or when they want.

A heating container has been developed and used to solve drawbacks stated above in the heat retaining container, which is composed of various components such as a sealed heating unit bag with food contents within a body thereof, etc. Foods may be heated as follows: to take out and open the bag; to pour water into the bag; to let it generate heats by reacting to the water.

Heating containers which may be carried and used to warm a feeding bottle for an infant or a toddler were disclosed in the Korean Patent Publication No. 1105660 (hereinafter referred to as the “Cited Reference 1”) and the Korean Utility Model Publication No. 0446651 (hereinafter referred to as the “Cited Reference 2”).

In the Cited Reference 1, a heating container is supplied separately from a feeding bottle. A heating pack is incorporated in a body of the heating container, which is composed of a heating substance containment part and a water reservoir. An upper part of the body of the hearing container is equipped with a heat transfer plate. A bottom of the feeding bottle, which contacts the upper part of the body of the heating container, is also equipped with its own heat transfer plate which receives heat from the heating transfer plate in the heating container.

However, the configuration of the heating container in the Cited Reference 1 is complicated. Furthermore, it is hard to be widely used because a feeding bottle therefor shall also be equipped with its own heat transfer plate.

In the Cited Reference 2, a heating container is composed of the following components: an outer container with open/shut means on upper part thereof; an inner container with open/shut means on upper part thereof, made of metals and housed within the outer container; retaining means which are combined with an lower part of the outer container and prevents the inner container from escaping and; a heating unit which is housed at the lower part of the inner container.

However, the configuration of the heating container in the Cited Reference 2 is also complicated, because the inner container is separately housed in the outer container which contains liquid contents. Thus, a generally used feeding bottle may not be used with this invention without difficulty.

References Cited

Patent Publication No. 1105660 (published on Jan. 18, 2012)

Korean Utility Model Publication No. 0446651 (published on Nov. 18, 2009)

### SUMMARY OF INVENTION

### Technical Objectives that the Invention Intends to Achieve

The present invention intends to resolve the drawbacks in the existing heating containers and to provide a portable heating container which enables foods to be conveniently heated by storing the foods in an inner food container.

### Structure and Characteristic of the Invention

The present invention, a portable heating container, comprises an outer container into which an inner container which contains foods is inserted and the heating substances that is to react to water are housed; and cover members which are detachably fixed to an open entrance of the outer container, in which a through-hole through which the inner container penetrates is formed, and in which an emission groove through which water vapors are emitted is formed around the through-hole.

A container seating part is formed within the inner side of the outer container, with which the inner container is seated apart from an inner bottom of the outer container.

The container seating part is extended from the side of the outer container.

A water line which determines a water level is formed in the side of the outer container.

Support projections are protruded on a concentric circle on a rim of bottom of the outer container, and reinforcing ribs which reinforce a bottom surface of the outer container are protruded in the inside of the support projections.

Cover members comprise a ring-shaped fixing part to be fixed on the entrance of the outer container with a fitting groove in which the entrance of the outer container is inserted; and a sealing part which is extended from an inner surface of the fixing part, whose inner diameter is smaller than an inner diameter of the inner container, which bends downward and adheres to the outside of the inner container with its elasticity when the inner container penetrates, which returns to its original state when the inner container is separated, and on which the water vapor emission groove is formed.

An edge part which is extended outward is formed on the entrance of a container body which constitutes the outer container. A latching part which is extended downward and separated from the container body is formed on a rim of the edge part. The fixing part of the cover members is formed to cover the edge part as well as the latching part.

### EFFECTS OF THE INVENTION

The present invention can conveniently heat a food container outdoors and reduce production costs due to its simple configuration. The present invention is also easy to use.

### BRIEF DESCRIPTION OF THE DRAWINGS

FIG. 1 is a perspective view of the feeding bottle inserted into the portable heating container according to a preferred embodiment of the present invention.

FIG. 2 is a front view of heating the feeding bottle by heating water with a heater housed in the portable heating container according to a preferred embodiment of the present invention.

FIG. 3 is a perspective view of the portable heating container according to a preferred embodiment.

FIG. 4 is an exploded perspective view of FIG. 3.

FIG. 5 is a cross-sectional view along the line A-A of FIG. 3.

FIG. 6 is a cross-sectional view along the part B of FIG. 4.

### DETAILED DESCRIPTION OF EXEMPLARY EMBODIMENTS

Hereinafter, the present invention is described in more detail with reference to attached drawings.

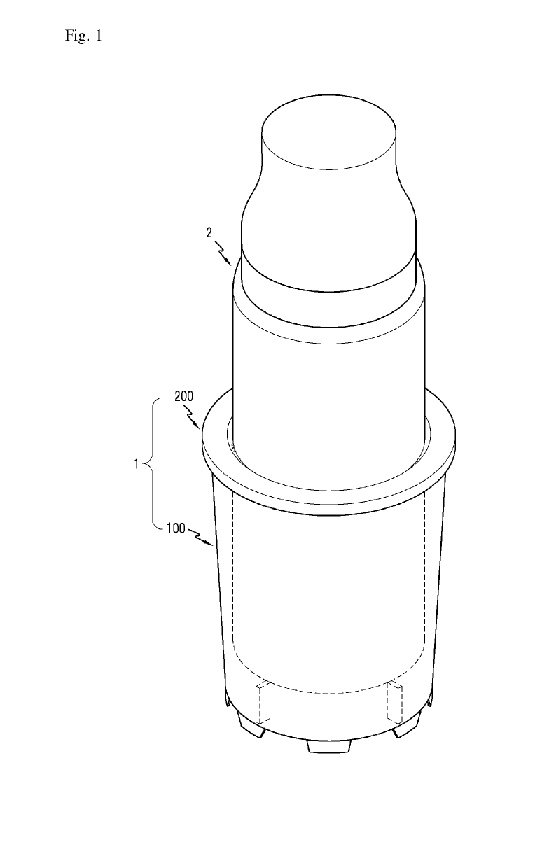

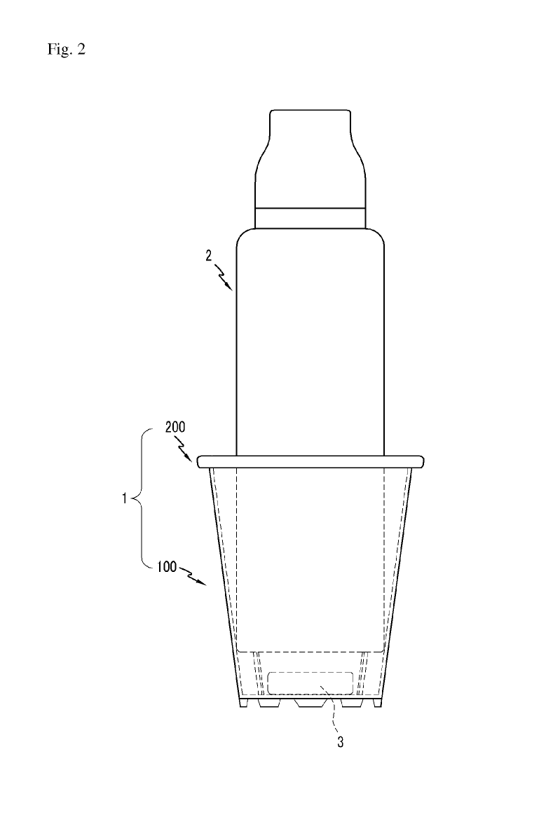

FIG. 1 is a perspective view of the feeding bottle inserted into the portable heating container according to a preferred embodiment of the present invention, and FIG. 2 is a front view of heating the feeding bottle by heating water with a heater housed in the portable heating container according to a preferred embodiment of the present invention.

According to the present invention, the portable heating container 1, the feeding bottle 2 as the inner container is inserted through a center of the cover members 200 which is fixed at the entrance of the outer container 100 which houses water and the heater 3. As the time passes posterior to the insertion of the feeding bottle 2, the water vapor is generated as the water boils with the reaction of the water and the heater 3. The water vapor heats the feeding bottle 2 as it contacts the feeding bottle 2. The generated vapor is emitted outward through the cover members 200.

The milk in the feeding bottle 2 may be heated to maintain its temperature to 37 which is the same temperature as that of mother's milk by adjusting composition of the heater 3, weight of water which reacts with the heater 3, emission of water vapor through the cover members 200. In case where the inner container is a food container other than the feeding bottle 2, such as a sake container, etc, the food container may be heated to a temperature that a user wants by adjusting conditions stated above.

On the other hand, the feeding bottle 2 is inserted to the outer container 100 with the cover members 200 attached to the outer container 100 by inserting the feeding bottle 2 through the through-hole 221, stated below, which is formed at the center of the cover members 200. The feeding bottle 2 may be detached from the outer container 100 only by pulling it out.

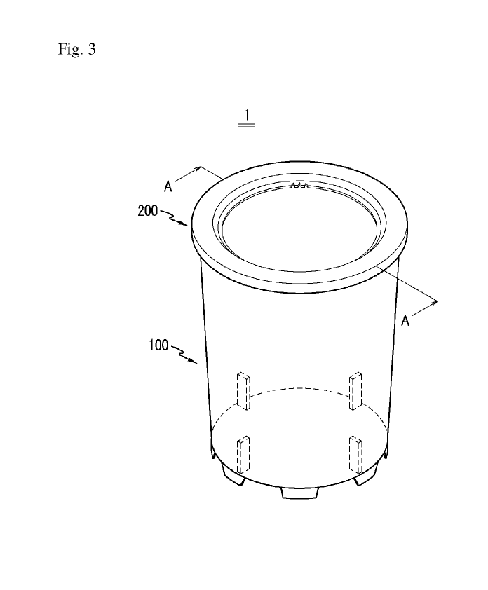

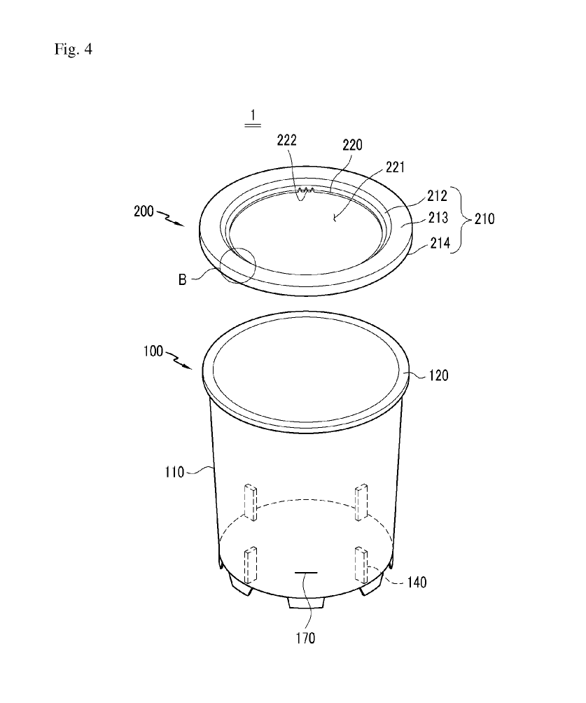

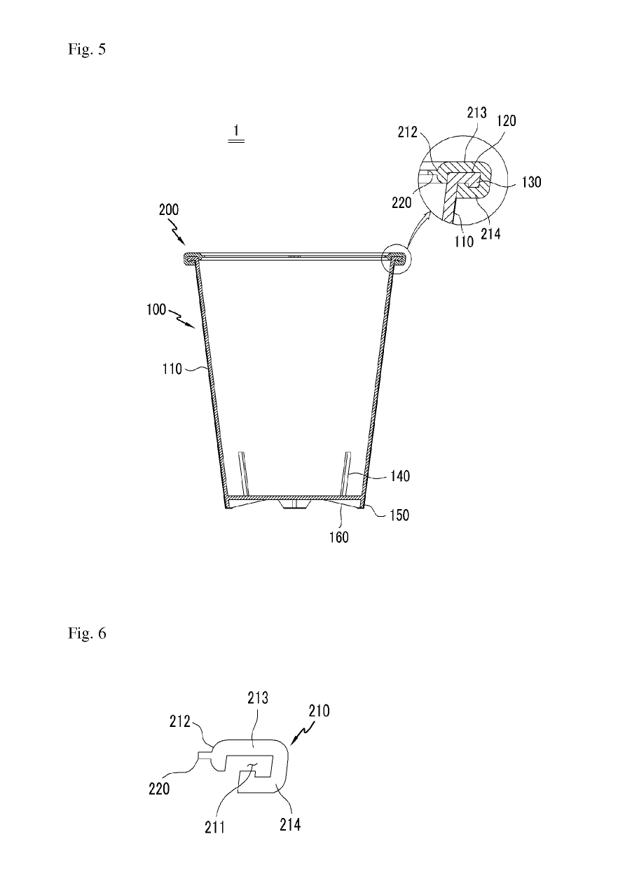

FIG. 3 is a perspective view of the portable heating container according to a preferred embodiment, FIG. 4 is an exploded perspective view of FIG. 3, FIG. 5 is a cross-sectional view along the line A-A of FIG. 3, and FIG. 6 is a cross-sectional view along the part B of FIG. 4.

The present invention, the portable heating container 1 includes the outer container 100 and the cover members 200.

The outer container 100 into which the feeding bottle is inserted and which houses the water and the heater is composed of the container body 110, the edge part 120, the latching part 130, the container seating part 140, the support projections 150, and the reinforcing ribs 160.

The container body 110 has accommodating spaces for the feeding bottle, water and the heater. The upper part of the container body 110 is exposed and the cross-section thereof is circular. The water line 170 which determines a water level is formed in the bottom side of the container body 110. The water line 170 may be formed in a shape of grooves or projections.

The edge part 120 is extended outward from the upper part of the container body 110 and an upper side thereof may be formed as round. The latching part 130 is extended downward from the rim of the edge part 120 and separated from the container body 110. The cover members 120 are fixed in a shape to cover the upper part of the container body 110, the edge part 200 and the latching part 130. The cover members may be stably fixed and not be easily detached from the outer container 100 by the latching part 130.

The container seating part 140 make the feeding bottle 2 seat apart from the inner bottom of the container body 110 by extending inward from the side of the container body 110. The reaction of water with the heater occurs in a space between the bottom surfaces of the container body 110 and the feeding bottle 2. The container seating part 14 is arranged radially around a centerline which perpendicularly penetrates a center of the container body 110.

The support projections 150 are protruded on a concentric circle on a rim of bottom of the container body 110 and support the container body 110 to be separated from the bottom. The support projections 150 are formed to be separated from each other but may be formed continuously.

The reinforcing ribs 160 are protruded from the bottom of the container body 110 and reinforce strength of the bottom surface of the container body 110 by being formed radially on the inside of the support projections 150.

The cover members 200 are made of materials with elasticity such as silicon and include the fixing part 210 and the sealing part 220.

The fixing part 210 is in a ring-shape and fixed on the entrance of the container body 110. The fitting groove 211 is formed, in which the upper part of the container body 110, the edge part 120 and the latching part 130 are fastened. The fixing part 210 includes the container body contact surface 212 which contacts to the inner surface of the container body 110, the edge part contact surface 213 which is extended outward from the container body contact surface 212, and the latching part contact surface 214 which covers the edge part contact surface 213 and the latching part 130. Since the latching part contact surface 214 is formed in a bend-shape to cover the inside and outside of the latching part 130 and the bottom surface thereof, the fixing part is latched to the latching part 130. Thus, the fixing part 210 may be detached from the container body 110 only by pulling the fixing part 210 with strength.

As stated above, the fixing part 210 has its elasticity. Thus, in case where the fixing part 210 is fixed on the entrance of the container body 110, a user opens the entrance of the fitting groove 211 with strength. Once the fixing part 210 is fixed on the entrance of the container body 110, the entrance of the fitting groove 211 returns to its original state by its elasticity and the fixing part 210 is prevented from detaching.

The sealing part 220 is horizontally extended inward from an inner circumferential surface of the container body contact surface 212 which composes the fixing part 210 and is formed in a thin silicon-shaped membrane. The sealing part 220 is formed as a ring-shape, which has a container penetration hole 221 through which the feeding bottle penetrates. A number of water vapor emission grooves 222 which emits water vapor in the outer container 100 are formed around the container penetration hole 221. Since the inner diameter of the container penetration hole 221 is smaller than that of the feeding bottle, the fixing part 220 bends downward and attaches to the feeding bottle in case where the feeding bottle penetrates. It returns its original state in case where the feeding bottle is detached. The feeding bottle may be inserted and separated without difficulty due to the sealing part 220.

The present invention is explained in detail above on the basis of the preferential embodiment. However the preferential embodiment is only one of embodiments and a person having ordinary skills in the art may implement the present invention in various ways within the scope of the claims stated below.

1. A portable heating container, comprising:
an outer container into which an inner container which contains foods is inserted and the heating substances that is to react to water are housed; and
cover members which are detachably fixed to an open entrance of said outer container, in which a through-hole through which the inner container penetrates is formed, and in which an emission groove through which water vapors are emitted is formed around the through-hole.

2. The portable heating container according to claim 1, wherein a container seating part is formed within an inner side of said outer container, with which the inner container is seated apart from an inner bottom of the outer container.

3. The portable heating container according to claim 2, wherein said container seating part is extended from a side of said outer container.

4. The portable heating container according to claim 3, wherein a water line which determines a water level is formed in the side of said outer container.

5. The portable heating container according to claim 2, wherein support projections are protruded on a concentric circle on a rim of bottom of said outer container, and reinforcing ribs which reinforce a bottom surface of the outer container are protruded in an inside of said support projections.

6. The portable heating container according to claim 1, wherein said cover members comprise:
a ring-shaped fixing part to be fixed on the entrance of said outer container with a fitting groove in which the entrance of the outer container is inserted; and
a sealing part which is extended from an inner surface of said fixing part, whose inner diameter is smaller than an inner diameter of the inner container, which bends downward and adheres to ant-he outside of the inner container with its elasticity when the inner container penetrates, which returns to its original state when the inner container is separated, and on which said water vapor emission groove is formed.

7. The portable heating container according to claim 6, wherein an edge part which is extended outward is formed on the entrance of a container body which constitutes said outer container, a latching part which is extended downward and separated from the container body is formed on a rim of the edge part, and the fixing part of said cover members is formed to cover the edge part as well as the latching part.

8. The portable heating container according to claim 3, wherein support projections are protruded on a concentric circle on a rim of bottom of said outer container, and reinforcing ribs which reinforce a bottom surface of the outer container are protruded in an inside of said support projections.

9. The portable heating container according to claim 4, wherein support projections are protruded on a concentric circle on a rim of bottom of said outer container, and reinforcing ribs which reinforce a bottom surface of the outer container are protruded in an inside of said support projections.

10. The portable heating container according to claim 2, wherein said cover members comprise:
a ring-shaped fixing part to be fixed on the entrance of said outer container with a fitting groove in which the entrance of the outer container is inserted; and
a sealing part which is extended from an inner surface of said fixing part, whose inner diameter is smaller than an inner diameter of the inner container, which bends downward and adheres to an outside of the inner container with its elasticity when the inner container penetrates, which returns to its original state when the inner container is separated, and on which said water vapor emission groove is formed.

11. The portable heating container according to claim 3, wherein said cover members comprise:
a ring-shaped fixing part to be fixed on the entrance of said outer container with a fitting groove in which the entrance of the outer container is inserted; and
a sealing part which is extended from an inner surface of said fixing part, whose inner diameter is smaller than an inner diameter of the inner container, which bends downward and adheres to an outside of the inner container with its elasticity when the inner container penetrates, which returns to its original state when the inner container is separated, and on which said water vapor emission groove is formed.

12. The portable heating container according to claim 4, wherein said cover members comprise:
a ring-shaped fixing part to be fixed on the entrance of said outer container with a fitting groove in which the entrance of the outer container is inserted; and
a sealing part which is extended from an inner surface of said fixing part, whose inner diameter is smaller than an inner diameter of the inner container, which bends downward and adheres to an outside of the inner container with its elasticity when the inner container penetrates, which returns to its original state when the inner container is separated, and on which said water vapor emission groove is formed.

13. The portable heating container according to claim 10, wherein an edge part which is extended outward is formed on the entrance of a container body which constitutes said outer container, a latching part which is extended downward and separated from the container body is formed on a rim of the edge part, and the fixing part of said cover members is formed to cover the edge part as well as the latching part.

14. The portable heating container according to claim 11, wherein an edge part which is extended outward is formed on the entrance of a container body which constitutes said outer container, a latching part which is extended downward and separated from the container body is formed on a rim of the edge part, and the fixing part of said cover members is formed to cover the edge part as well as the latching part.

15. The portable heating container according to claim 12, wherein an edge part which is extended outward is formed on the entrance of a container body which constitutes said outer container, a latching part which is extended downward and separated from the container body is formed on a rim of the edge part, and the fixing part of said cover members is formed to cover the edge part as well as the latching part.
